(19) United States
(12) Patent Application Publication
(10) Pub. No.: US 2016/0212186 A1
(43) Pub. Date: Jul. 21, 2016

(54) DISPLAY SERVER COMMUNICATIONS CHANNEL

(71) Applicant: Hewlett-Packard Development Company, L. P., Houston, TX (US)

(72) Inventor: Thomas E Sandholm, Mountain View, CA (US)

(21) Appl. No.: 14/602,033

(22) Filed: Jan. 21, 2015

(51) Int. Cl. H04L 29/06; H04L 29/08

(52) U.S. Cl. CPC H04L 65/4069; H04L 67/02

(57) ABSTRACT

Techniques for displaying content on a display are provided. In one aspect, a relay server may receive a request to display content. The request may include an identifier that identifies the display. The request may also include an access code that is periodically updated. The access code may be displayed on the display. An indication of the request may be provided to a display server. The indication may be provided over a channel specific to the identified display. The indication may include the access code.

### BACKGROUND

The presence of mobile devices has become ubiquitous. Large portions of the population carry a smartphone, laptop, tablet, or some other mobile computing device with them wherever they go. The capabilities of these devices are also ever increasing. For example, most devices are minimally capable of storing content files, such as PowerPoint™ presentations. In fact, many devices are capable of displaying rich multimedia content, which may include audio and video.

### BRIEF DESCRIPTION OF THE DRAWINGS

FIG. 1 depicts an example of a system that may utilize the display techniques described herein.

FIG. 2 depicts another example of a system that may utilize the display techniques described herein.

FIG. 3 depicts an example of a flow diagram for pairing a content source with a display server, according to the techniques described herein.

FIG. 4 depicts an example of a flow diagram for pairing a content source with a display server and relaying content from the content source to the display server, according to the techniques described herein.

FIG. 5 depicts an example of a system including a display server in accordance with the techniques described herein.

### DETAILED DESCRIPTION

The ubiquity of mobile devices that can store and display content has changed the way that enterprises and people within an enterprise work. Previously, for example, a salesperson making a presentation to an enterprise customer may have prepared physical handouts to pass out to his customers during the presentation. In some cases, particularly when multimedia content (e.g. a video) is to be presented, the salesperson may bring a portable projector along with him as well as a screen on which to project. In essence, the salesperson would bring along anything needed for a successful presentation, as he could not count on any particular capability being present in the facilities provided by the enterprise.

Mobile devices capable of storing and displaying content have obviated the need to bring handouts or related content display support equipment. The mobile device itself is capable of both storing the content as well as displaying it. Thus, a presenter need only load his mobile device with the presentation content. In some cases, this may be sufficient. For example, in a presentation to an individual or small group, it may be possible, although not optimal, for all participants to huddle around a laptop or smartphone screen. As group size increases, this option becomes less viable.

As the use of mobile devices became more prevalent, enterprises recognized that providing content sharing capabilities within meeting spaces, such as conference rooms, may be beneficial. For example, an enterprise may equip conference rooms with projectors or display screens. Thus, a person with content contained on a mobile device need only connect to the content sharing capabilities installed in the conference room.

The ability to share content using the content sharing capabilities installed in a conference room assumes that a user's mobile device is able to connect to the conference room's sharing capabilities. There are numerous reasons why this assumption may not be true. One example may be connector incompatibility. For example, the mobile device may have a physical display output (e.g. VGA port) that is not compatible with the conference room's input (e.g. HDMI). Ensuring that every possible type of mobile device physical connection is compatible with the conference room sharing capabilities would be very difficult and potentially cost prohibitive.

In the case of software based solutions, the mobile device may be required to have certain software, such as a particular screen sharing software application, installed. It may be very difficult for content presenters to ensure that they always have the appropriate software installed for every type of sharing situation. Further exacerbating the situation is that often times screen sharing software requires all participants (e.g. the conference room and the mobile device) be on the same network. In an enterprise environment, security concerns may prevent connection to the enterprise network by devices unknown to the enterprise. These security concerns may limit the ability of outsiders, such as the salesperson mentioned above, to connect their mobile device to the conference room display capabilities.

The techniques described herein provide for a system wherein an arbitrary user, using an arbitrary device, connected to an arbitrary network is able to cause content to be displayed on a display screen. The display screen may be connected to a display server, the display server itself being on an arbitrary network. There is no need for the users mobile device to have any particular type of physical interface (e.g. VGA, HDMI, etc.) in order to display content on the display. The techniques also allow for the display server and the mobile device, also referred to as the content source, to be on any arbitrary network, so long as a public network (e.g. the Internet) is accessible from the arbitrary network. The techniques rely on standard programs and protocols, such as web browsers, Virtual Network Connection (VNC) protocols, Hypertext Transfer Protocol (HTTP) and firewall traversal protocols, thus requiring no specific software, such as specific screen sharing software, to be installed on the mobile device. The techniques also ensure that a user of the display is either within visual distance of the display, or is in contact with someone who is. This ensures that a display may not be taken over by a random actor.

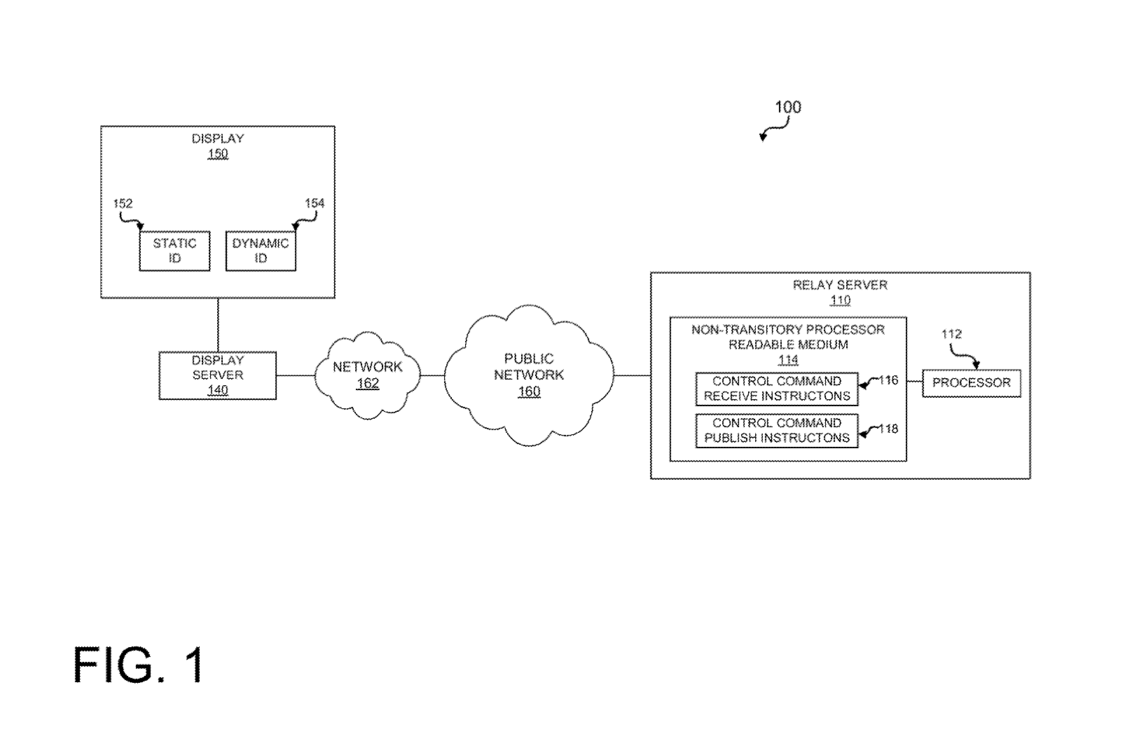

FIG. 1 depicts an example of a system that may utilize the display techniques described herein. System 100 may include a relay server 110, a display server 140, and a display 150. The relay server may be coupled to a public network 160. The display server may be connected to a network 162. The network 162 may be coupled to the public network 160.

The relay server 110 may include a processor 112 and a non transitory processor readable medium 114 containing a set of instructions thereon. The instructions may be executable by the processor and cause the processor to implement the functionality described herein. For example, the medium may include control command receiving instructions 116 and control command publishing instructions 118. The instructions 116 and 118 are described in further detail below.

The public network 160 may be any network that is accessible by the public, without any special or specific credentials. The most readily known example of a public network is the Internet. However, the techniques described herein are not limited to implementations in which the public network is the internet. Any network that does not require specific credentials for access is suitable for use with the techniques described herein. The network 162 may be any arbitrary network. The network 162 may be a public or private network, where a private network may require specific credentials in order for access to be granted. One example of a private network may include a corporate intranet. Access to the corporate intranet me be limited to employees of the corporation.

A private network may provide access to the public network. For example, access to a public network from the private network may be through a firewall or through a proxy server. Firewall traversal protocols and other techniques are available that allow for access to a public network from a private network while ensuring that the private network remains secure. The techniques described herein do not relay on any specific mechanism for access of the public network from the private network. Rather, any suitable technique for such access is compatible with the techniques described herein. In other words, the techniques described herein work as long as the display server 140 is able to access the public network 160, regardless of the specific techniques used to enable that access.

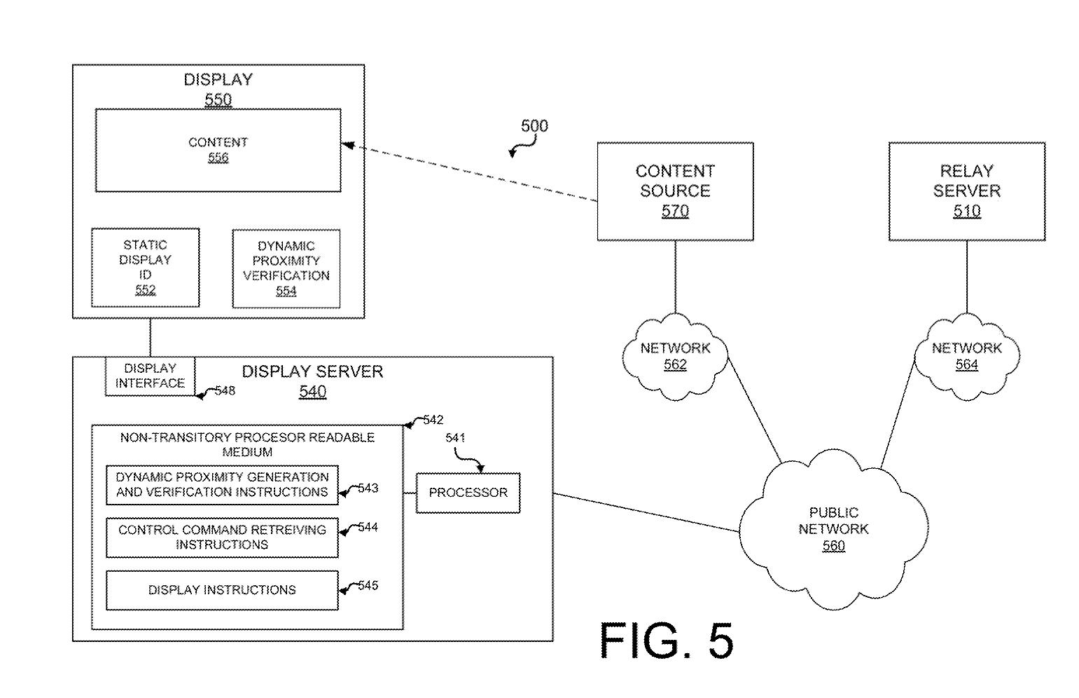

The display server 140 may be a computing device that is coupled to the network 162. The particular form factor of the display server is relatively unimportant. Some example form factors for the display server are described below in reference to FIG. 5. What should be understood is that the display server is a computing device that provides a bridge, through the networks 160, 162, between the relay server 110 and the display 150.

The display 150 may be any type of display that is able to display content. For example, the display may be a flat screen monitor, such as a Liquid Crystal Display (LCD) or Light Emitting Diode (LED) monitor. The display may be a projector that causes content to be displayed on a surface, such as a movie screen. The particular form of the display is unimportant. The techniques described herein are suitable for use with any device that is able to cause content to be displayed to a user. During periods of time when the display is available to display content, the display server may cause a static ID 152 and a dynamic ID 154 to be displayed. The use of these IDs is described below.

In operation, the display server 140 may cause a static identifier 152 to be displayed on the display 150. The static ID, which may also be referred to as a static display identifier portion, is used to identify the particular display on which content is to be shown. Although FIG. 1 depicts a one to one relationship between a display and a display server, the techniques described herein are not so limited. A single display server could serve multiple displays and vice versa. The display ID defines on which display content will appear.

In some implementations, the static ID 152 may be a simple character sequence (e.g. “ABCD”), while in other implementations, the static ID may be a more descriptive string (e.g. “CONFERENCE ROOM A”). In the conference room in which the display is located, instructions may be provided to connect to a particular web page and supply the static ID. Thus the particular display where content will be shown is identified. In yet other implementations, the static ID may be embedded into a Universal Resource Locator (URL), such that a user connecting the URL using a web browser will access a web page associated with the particular display. Thus the step of entering the static ID may be eliminated. In some implementations, instead of being a URL that is type by a user, the static ID may be included in a visual code, such as a Quick Response code (QR code). Scanning the QR code may result in landing on a web page associated with the particular display. Regardless of implementation, the static ID may be used to identify a particular display.

A dynamic ID 154, which may also be referred to as a dynamic proximity verification portion, may also be included on the display. For example, the dynamic ID may be a simple character sequence (e.g. “1234”), that is periodically changed. For example, a new dynamic ID may be generated every 30 seconds, ever, minute, every 15 minutes, or on any other period. As will be explained in further detail below, the dynamic ID may be used to ensure that a user attempting to display content on the display is within visual proximity (or is at least in contact with someone who is in visual proximity) with the display.

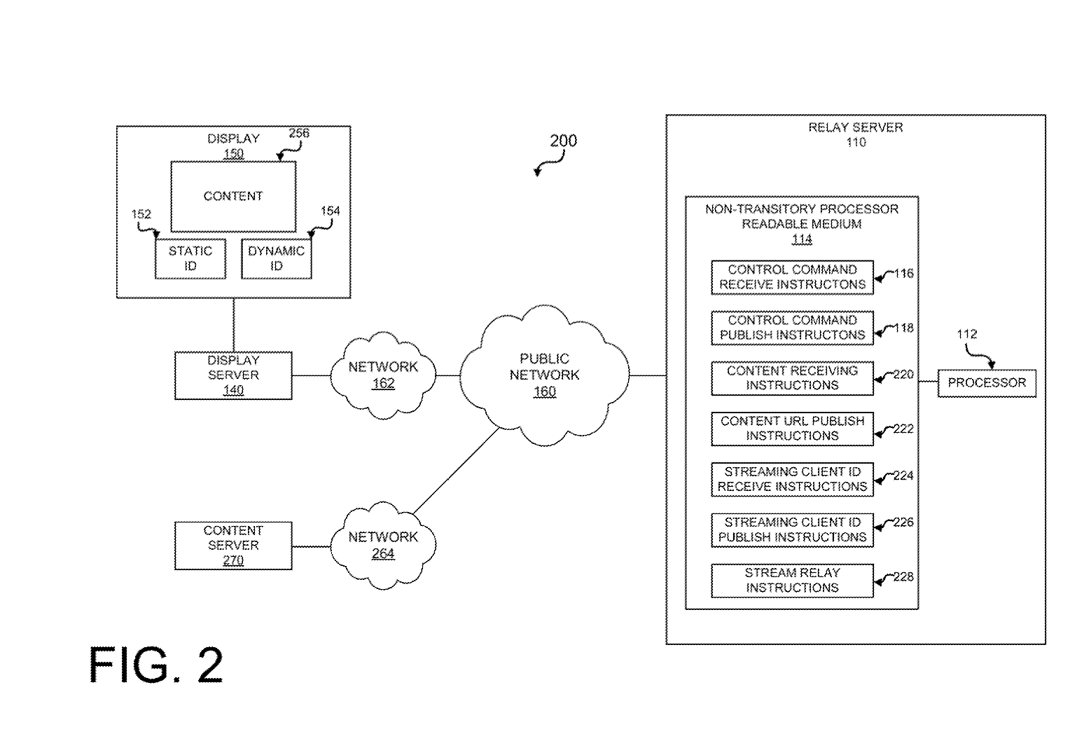

FIG. 2 depicts another example of a system 200 that may utilize the display techniques described herein. Many of the components described in FIG. 2 are the same as those described in FIG. 1. For ease of description, the element reference numerals used in FIG. 1 are reused in FIG. 2 and a duplicate description is omitted. System 200, in addition to the elements described with respect to FIG. 1, may also include a content server 270, a network 264, and further instructions contained on the medium 114.

The content server 270 may be any type of device that is capable of storing content. In some cases, the content server may also be able to display the content. Some examples of content servers may include laptop computers, notebooks, netbooks, smartphones, or any other similar type of device. What should be understood is that the techniques described herein are suitable for use with any type of device which can access a network, stores content, and has suitable applications (e.g. a web browser) installed. The particular form of the device is unimportant.

The content server 270 may be coupled to a network 264. The particular form of network 264 is relatively unimportant, as long as the content server is able to access the public network 160 though network 264. It should be understood that network 162 and network 264 need not be the same network, and in most cases will not be the same network. For example, network 162 may be a private enterprise network and network 264 may be a different private network, such as the network provided by a cellular telephone company. However, it should be understood that devices connected to either of the networks 162, 264 are able to access the public network 160.

The medium 114 may also include additional instructions. For example, content receiving instructions 220, content URL publishing instructions 222, streaming client ID receive instructions 224, streaming client ID publish instructions 226, and stream relay instructions 228. The function of these instructions is described in further detail below.

The operation of system 200 will now be described through an example use case. For purposes of this use case, assume that a content presenter is in possession of a content server 270. For example, the content server may be a smartphone. Assume the content server contains a presentation file (e.g. a PowerPoint™ presentation) and a video file. The content presenter may enter a conference room that has implemented the techniques described herein.

The content presenter may first pair his content server 270 with the display. As explained above, the display server may cause a static ID 152 to be displayed on the display 150 during times when pairing is allowed. Depending on the implementation, the conference room may include a URL for a web page where the static identifier may be entered, the URL may include the static identifier, or another mechanism, such as a QR code associated with the display may be used. What should be understood is that a request for pairing the content server with the display may be sent by the content server to the relay server. The request may be sent using a protocol such as HTTP.

The request may be sent by the content server over network 264, which may be a private network. In addition to the static ID, the request may include a dynamic ID 154. As explained above, the dynamic ID may be periodically updated by the display server. The request may be destined for a relay server 110. The relay server may be accessible over a public network 160. Thus, the request originates at the content server, traverses network 264, to network 160, then to the relay server 114.

The relay server 110, may execute the control command receive instructions 116 with processor 112. The control command receive instructions may cause the relay server to receive the pairing request from the content server. The relay server may determine the particular display that is being paired by analyzing the static ID 152 included in the request. As explained above, the static ID may be explicitly included in the request or the URL used to communicate with the relay server may have the static ID embedded. Regardless of the particular implementation, the relay server is aware of the specific display that is being paired to the content server.

The relay server, using the control command publish instructions 118, may then publish the pairing request on a communications channel. The communications channel may be accessible by the display server 140 connected to the specific display 150 that is being paired. The communications channel may be inaccessible to all other display servers, content servers, or any other element in general. In one implementation, the communications channel may be a web services based publication/subscription channel. The subscriber to the channel may be the display server and the publisher may be the relay server. Thus, the display server connected to the display being paired may subscribe to the communications channel.

The relay server may publish the pairing request control command on the communications channel. Included in the command may be the dynamic ID 154 that was being displayed by the display 150. In other words, when attempting to pair with the display, the content presenter may view the dynamic ID presented on the screen and include that ID in the request to pair with the display and the dynamic ID is passed along to the display server. The display server may then retrieve the control command from the communications channel, using a protocol such as HTTP. The display server may compare the received dynamic ID with the dynamic ID that is currently being sent to the display. If there is a match, it means that the content presenter is within visual proximity of the display 150 and should be allowed to pair with the display.

This results in an effect similar to a limited length physical cable (e.g. VGA cable) in a conference room. In the case of a physical cable, if a user is not close enough to the display, he will not be able to present because he physically cannot connect to the cable. Similarly, in the techniques presented herein, if a user is not within visual proximity of the display, he can't see the dynamic ID and should not be allowed to pair with the display. It should be noted that the techniques described herein also allow for a remote content presenter, as long as he is in contemporaneous contact with someone who can see the display (e.g. someone sitting in the conference room). For example, the person sitting in the conference room may be able to relay the dynamic ID to the remote content presenter (via e.g. instant message, phone call, e-mail, etc.). Because all communications between the content server and the display server go through the relay server, which is accessible over the public network 160, there is no requirement that the content presenter and the display server be co-located.

At this point, the content server 270 belonging to the content presenter and the display 150 may now be called paired. The content presenter may now desire to display content 256 on the display 150. For example, the content presenter may wish to display a PowerPoint™ presentation. The content presenter may cause the content file, in this example, the PowerPoint™ file to be uploaded to the relay server 110. The content server may upload the file using a protocol such as HTTP, or any other suitable protocol. The techniques described herein are not dependent on the use of any particular protocol.

The relay server 110, using the content receiving instructions 220, may receive the content file from the content server. The relay server may store the content file, ensuring that at minimum the extension for the file type is preserved. The reason for preserving the file type described below. The relay server may then publish the availability of the file on the communications channel. For example, using the content URL publish instructions 222, the relay server may publish a URL pointing to the stored content file. The display server 140, which as described above is subscribed to the communications channel, may retrieve the content file from the relay server. The content file may then be deleted form the relay server.

The display server 140 may then examine the file extension of the content file (e.g. .ppt for a PowerPoint™ file). Because the file extension was preserved, the display server is informed as to the application to be used to display the content. The display server may then launch the proper application and display the content file using that application.

Another type of content that may be displayed is streaming content. For example, the content server 270 may have content, such as a video, that is to be displayed on the content server and then streamed to the display 150. Using available steaming protocols, such as Virtual Network Connect (VNC) or Web Real Time Communication (WebRTC), a streaming session may be established between the content server and the display server. Although specific streaming technologies are mentioned, it should be understood that the techniques described herein are not dependent on any particular streaming technology.

The content server may launch a streaming server program. In many cases, the streaming server application program may already be installed on the content server. However, if it is not, a Universal Serial Bus (USB) memory stick may be present in the conference room and contain the streaming server. Thus, the content presenter may need to insert the USB memory stick in order to launch the streaming server program. The streaming server may start up in listening mode and add as a client a randomly generated streaming client ID. This randomly generated streaming client ID may be sent to the relay server using a procedure very similar to the one described above in which the static ID is sent to the relay server. For example, the streaming client ID receive instructions 224 may be used for this purpose.

The relay server 110 may then publish the streaming client ID over the communications channel, similar to the publication of the control commands. The relay server may use the streaming client ID publish instructions 226 to publish the streaming client ID to the communications channel. The display server 140 may then retrieve the relay ID over the communications channel. The display server may then launch a streaming client viewer application program. The streaming client ID may be passed to the program.

The streaming client viewer application on the display server 140 may then open a streaming session with the relay server, passing in the streaming client ID. Using the stream relay instructions, the relay server may open a streaming session with the streaming program on the content server 270, again using the streaming client ID that was passed in from the display server. The content server may then begin streaming content to the relay server which in turn streams the content 256 to the display server 140 to be shown on the display 150.

While content is being displayed, it may be necessary to navigate through the content. For example, in the case of a PowerPoint™ presentation, it may be necessary to move slides forward or backward. In some implementations, the display server may be outfitted with local control devices (e.g. mouse) to enable local control of the application on the display server that is being used to display the content. In other implementations, control commands may be sent using the relay server. For example, control commands could be sent by sending the commands form the content server 270 to the relay server 110. The relay server may then publish the command for retrieval by the display server 140 over the communications channel. The display server may then send the command to the application being used to display the content.

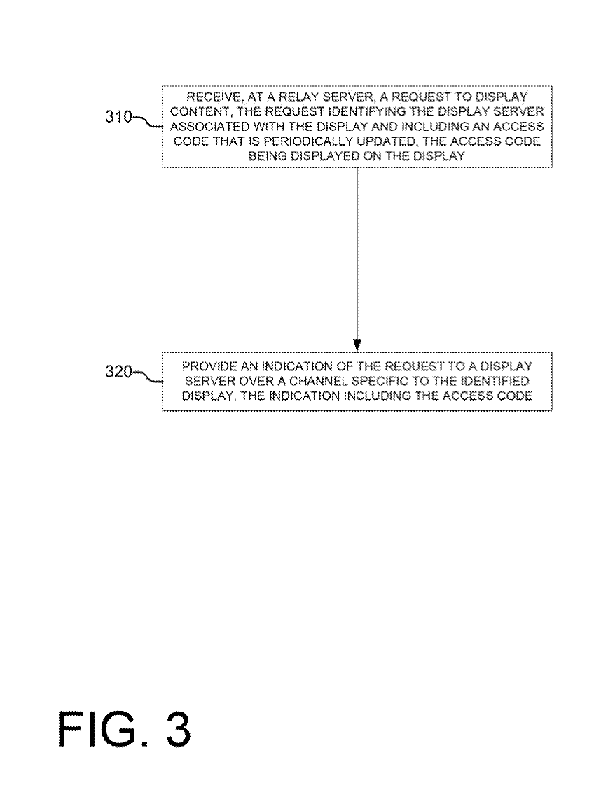

FIG. 3 depicts an example of a flow diagram for pairing a content source with a display server, according to the techniques described herein. In block 310 a request to display content may be received at a relay server. As explained above, the request may be in the form of access to a URL or result from the scanning of a QR code. The request may identify the display server associated with the display. In other words, the request identifies which display server is connected to and controls the display that content is to be displayed on. The request may also include an access code that is periodically updated and displayed on the display. For example, the access code may be the dynamic ID that was described above.

In block 320, an indication of the request may be provided to a display server over a channel specific to the identified display. The indication may include the access code. In other words, the request may be published on a communications channel that is accessible by the display server associated with the display. The communications channel may be specific to each display.

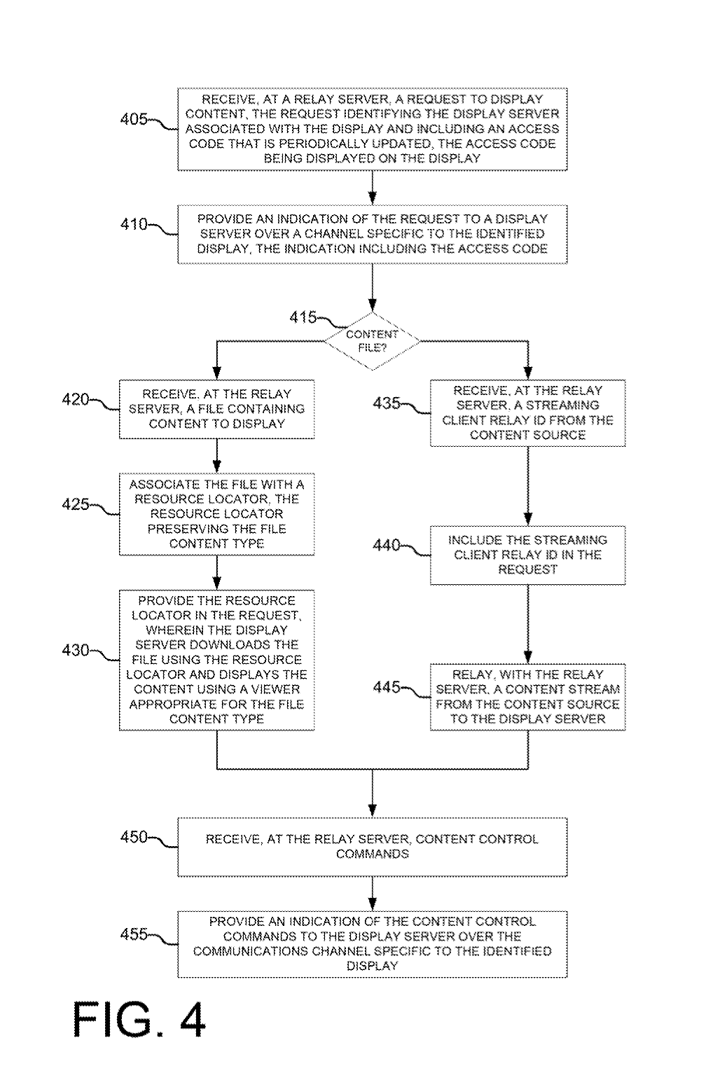

FIG. 4 depicts an example of a flow diagram for pairing a content source with a display server and relaying content from the content source to the display server, according to the techniques described herein. In block 405, just as above in block 310, a request to display content may be received. In block 410, just as above in block 320, and indication of the request may be provided to a display server.

In block 415, a path through the flow diagram is determined based on the type of content that is to be displayed. It should be understood that the relay server is not determining the content type in block 415, but rather the flow through the block diagram is different based on the content type (file vs streaming) that is to be displayed. If a content file, such as a PowerPoint™ file is to be displayed, the process moves to block 420. If the content type is streaming media, the process moves to block 435. In block 420, a file containing content to be displayed may be received at a relay server. For example, using protocols such as HTTP a content source may send a content file to the relay server. In block 425, the file may be associated with a resource locator. The resource locator may preserve the file content type. For example, the resource locator may be a URL and may preserve the file extension of the file that was received. The file content type may also be included in the upload by specifying the Multi-Purpose Internet Mail Extension (MIME) type of the file.

In block 430, the resource locator may be provided in the request. The display server may download the file using the resource locator and display the content using a viewer appropriate for the file content type. In other words, the display server may use the resource locator, such as a URL, and download a copy of the content file. The download may include the previously uploaded MIME type. The display server may then use the file extension or MIME type to determine the proper viewing application. The display server may launch the appropriate viewing application and display the content on the display.

In the case of streaming content, the flow chosen at block 415 moves to block 435, in which a streaming client relay ID may be received from the content source at the relay server. The streaming relay ID may identify the source of content to be streamed. In block 440, the streaming client relay ID may be included in the request. In other words, the streaming client relay ID may be included in the request and retrieved by the display server, thus informing the display server of the source of the content stream.

In block 445, the relay server may relay a content stream from the content source to the display server. In other words, the display server may establish a streaming session with the relay server, and the relay server may establish a streaming session with the content server. The relay server may then relay the content from the content server to the display server. The streaming client relay ID may be used to ensure that the proper content stream is being relayed.

In block 450, content control commands may be received at the relay server. Content control commands may include commands such as advance a slide, go back a slide, play content, pause content, or any other such command. In block 455 and indication of the content control commands may be provided to the display server over the communications channel specific to the identified display. Thus, content control commands may be delivered to the display server that is connected to the display that is displaying the content.

FIG. 5 depicts an example of a system including a display server in accordance with the techniques described herein. System 500 may include a relay server 510, a content source 570, a public network 560, and private networks 562, 564. These elements are similar to those described with respect to FIGS. 1 and 2. For purposes of clarity, the descriptions of those elements are not repeated here.

System 500 may also include a display server 540 and a display 550. The display server 540 may include a processor 541, a non-transitory processor readable medium 542 coupled to the processor, and a display interface 548. The display interface may couple the display server to the display 550.

The medium 542 may contain instructions thereon, which when executed by the processor cause the processor to implement the techniques described herein. For example, the medium may include dynamic proximity generation and verification instructions 543. The proximity generation instructions may be used to generate the access code that is used to verify that a content presenter is within visual proximity to the display. The generated dynamic proximity verification 551 portion may be displayed on the display.

The medium may also include control command receiving instructions 544. As explained above, the display server may retrieve control commands from the relay server over a communications channel. The control command receiving instructions may cause the display server to retrieve control commands from the relay server over the communications channel. For example, the control command receiving instructions may be used to retrieve a control command containing the dynamic proximity and static display ID 552 portions from the display 550. The verification instructions may then ensure that the content presenter has provided the proper code that is currently being displayed.

The medium may also include display instructions 545. The display instructions may cause the display server to retrieve content files from the relay server or being a streaming content relay session as described above. For example, the display instructions may cause the display server to retrieve a content file as described above and display the content 556 using the appropriate application for that content type. The display instructions may cause an appropriate steaming content viewer to launch and display streaming content relayed for the relay server.

The display server 550 may include a display interface 548. The display interface may be used to connect the display server to the display. For example, the display interface may be one of a VGA, DisplayPort, HDMI, or any other suitable interface. It should be understood that the techniques described herein are not limited to any particular form factor for a display server. The display server may be a standalone computer, included on a dangle that is attached to the display, integrated into the display, or in any other suitable form.

We claim:

1. A method of displaying content from a content source on a display comprising:
receiving, at a relay server, a request to display content, the request identifying the display server associated with the display and including an access code that is periodically updated, the access code being displayed on the display; and
providing an indication of the request to a display server over a communications channel specific to the identified display, the indication including the access code.

2. The method of claim 1 wherein the access code is periodically updated by the display server and the display server discards the request when the access code in the request does not match the access code displayed at the time of the request.

3. The method of claim 1 wherein the relay server is accessible via a public network and the display server and content source are connected to any network with access to the public network.

4. The method of claim 1 further comprising:
receiving, at the relay server, a file containing content to display;
associating the file with a resource locator, the resource locator preserving the file content type; and
providing the resource locator in the request, wherein the display server downloads the file using the resource locator and displays the content using a viewer appropriate for the file content type.

5. The method of claim 1 further comprising:
receiving, at the relay server, a streaming client relay ID from the content source;
including the streaming client relay ID in the request;
relaying, with the relay server, a content stream from the content source to the display server.

6. The method of claim 5 wherein the content source views the relay server as the destination of the content stream and the display server views the relay server as the source of the content stream.

7. The method of claim 1 wherein communication between the display server, the relay server, and the content server utilizes the hypertext transfer protocol (HTTP).

8. The method of claim 1 further comprising:
receiving, at the relay server, content control commands; and
providing an indication of the content control commands to the display server over the communications channel specific to the identified display.

9. The method of claim 6 wherein the content source includes a Virtual Network Computing (VNC) server and the display server includes a VNC client.

10. A non-transitory processor readable medium containing a set of instructions thereon, which, when executed by a processor cause the processor to:
receive a control command over a publically available network, the content control command including a static display identifier portion and a dynamic proximity verification portion; and
publish the received control command on a communications channel associated with a display server coupled to a display identified by the static display identifier, wherein the communications channel is accessible by the display server over a publically accessible network.

11. The medium of claim 10 further comprising instructions to:
receive a content file, the content file including a file type, and associating the content file with a uniform resource locator (URL);
publish the URL associated with the content file to the communications channel.

12. The medium of claim 10 further comprising instructions to:
receive a streaming client relay ID from a content server;
publish the received streaming client relay ID to the communications channel; and
relay a content stream between the content server and the display server.

13. The medium of claim wherein the communications channel uses the hypertext transfer protocol.

14. A system comprising:
a display; and
a display server coupled to the display, the display server to retrieve a control command from a relay server over a communications channel accessible via a public network, the display server further to compare a dynamic proximity verification portion in the control command to a previously generated and displayed dynamic proximity verification portion, wherein the control command is discarded based on the comparison.

15. The system of claim 14 wherein the communications channel is a hypertext transport protocol communications channel.
